(19) United States
(12) Patent Application Publication
(10) Pub. No.: US 2025/0293827 A1
(43) Pub. Date: Sep. 18, 2025

(54) Methods And Apparatus For Beam Activation Procedure In Mobile Communications

(71) Applicant: MediaTek Inc., Hsinchu City (TW)

(72) Inventors: Yi-Ru Chen, Hsinchu City (TW); Cheng-Rung Tsai, Hsinchu City (TW)

(21) Appl. No.: 19/069,171

(22) Filed: Mar. 3, 2025

Related U.S. Application Data
(60) Provisional application No. 63/564,525, filed on Mar. 13, 2024.
(60) Provisional application No. 63/566,416, filed on Mar. 18, 2024.

(51) Int. Cl. H04L 5/00; H04W 24/10

(52) U.S. Cl. CPC H04L 5/0048; H04L 5/0053; H04W 24/10

(57) ABSTRACT

Beam activation procedures with respect to user equipment and network node are described. An apparatus may transmit a measurement report to the network according to a reporting configuration. The measurement report indicates that at least one reference signal (RS) resource has been synchronized by the apparatus. The apparatus may receive an activation command from the network. The activation command may indicate a target transmission configuration indicator (TCI) state which is not in an active TCI state list. The apparatus may determine whether the RS resource associated with the target TCI state has been reported as synchronized. The apparatus shall be able to receive downlink (DL) channel with the target TCI state from the network after an acknowledgement from the apparatus for activation command is received by the network in an event that the RS resource associated with the target TCI state has been reported as synchronized in the measurement report.

### CROSS REFERENCE TO RELATED PATENT APPLICATION(S)

The present disclosure is part of a non-provisional application claiming the priority benefit of U.S. Patent Application No. 63/564,525, filed 13 Mar. 2024, and U.S. Patent Application No. 63/566,416, filed 18 Mar. 2024. The contents of aforementioned applications are herein incorporated by reference in their entirety.

### TECHNICAL FIELD

The present disclosure is generally related to mobile communications and, more particularly, to beam activation procedure with respect to user equipment (UE) and network apparatus in mobile communications.

### BACKGROUND

Unless otherwise indicated herein, approaches described in this section are not prior art to the claims listed below and are not admitted as prior art by inclusion in this section.

In conventional beam management procedure, the network node may send a TCI state activation command to activate at least one target transmission configuration indicator (TCI) state(s), where the target state(s) can be not in the active TCI state list. If the UE receives the TCI state activation command in slot n activating a target TCI state which is a known TCI state, the UE may be able to receive physical downlink control channel (PDCCH)/physical downlink shared channel (PDSCH) with the target TCI state at the first slot that is after slot

$$n + {T}_{H A R Q} + 3 {N}_{slot}^{subframe , μ} + {TO}_{k} * \frac{{T}_{first - SSB} + {T}_{S S B - p r o c}}{NR slot length} ,$$

where the term of

$$\frac{{T}_{first - SSB} + {T}_{S S B - p r o c}}{NR slot length}$$

is the time to receive and process the first SSB transmission after the TCI state activation command is decoded by the UE. TOₖ=1 if the target TCI state is not in the active TCI state list, TOₖ=0 otherwise. That is, the UE needs to perform the extra SSB reception associated with the target TCI state after receiving the TCI state activation command, if the target TCI state is not in the active TCI state list, to ensure that the UE synchronizes with the target TCI state by obtaining and storing the quasi-co-located (QCL) properties of the synchronization signal block (SSB) associated with the target TCI state. In the other word, if the UE has obtained and stored the QCL properties of the SSB associated with the target TCI state, it is considered as that the UE has synchronized with the target TCI state.

In fact, for activating a target TCI state, the time reserved for the extra SSB reception after the TCI state activation command is not needed, when UE has synchronized with the target TCI state. However, the network (NW) may always assume that the time reserved for the extra SSB reception is required for UE, since the NW does not have the knowledge of that which TCI state(s) has already been synchronized by the UE.

Accordingly, how to reduce the activation latency in the beam activation procedure becomes an important issue for the newly developed wireless communication network. Therefore, there is a need to provide proper schemes to shorten the activation latency and improve the beam activation procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to beam activation procedure with respect to user equipment (UE) and network apparatus in mobile communications. It is believed that the above-described issue would be avoided or otherwise alleviated by implementing one or more of the proposed schemes described herein.

In one aspect, a method may involve an apparatus receiving a reporting configuration from a network. The method may also involve the apparatus transmitting a measurement report to the network according to the reporting configuration. The measurement report may indicate that at least one reference signal (RS) resource has been synchronized by the apparatus. The method may further involve the apparatus receiving an activation command from the network. The activation command may indicate a target transmission configuration indicator (TCI) state which is not in an active TCI state list. The method may further involve the apparatus determining whether the RS resource associated with the target TCI state has been reported as synchronized in the measurement report. The method may further involve the apparatus being able to receive downlink (DL) channel with the target TCI state from the network after an acknowledgement from the apparatus for the activation command is received by the network in an event that the RS resource associated with the target TCI state has been reported as synchronized in the measurement report.

In another aspect, a method may involve a network transmitting a reporting configuration to a user equipment (UE). The method may also involve the network receiving a measurement report from the UE during a period. The measurement report may indicate that at least one RS resource has been synchronized by the UE. The method may further involve the network transmitting an activation command to the UE. The activation command may indicate a target TCI state which is not in an active TCI state list. The method may further involve the network transmitting DL channel with the target TCI state to the UE after the network receives an acknowledgement from the UE for the activation command in an event that the RS resource associated with the target TCI state has been reported as synchronized in the measurement report.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of a beam activation procedure in which various solutions and schemes in accordance with the present disclosure may be implemented.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions beam activation procedure with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

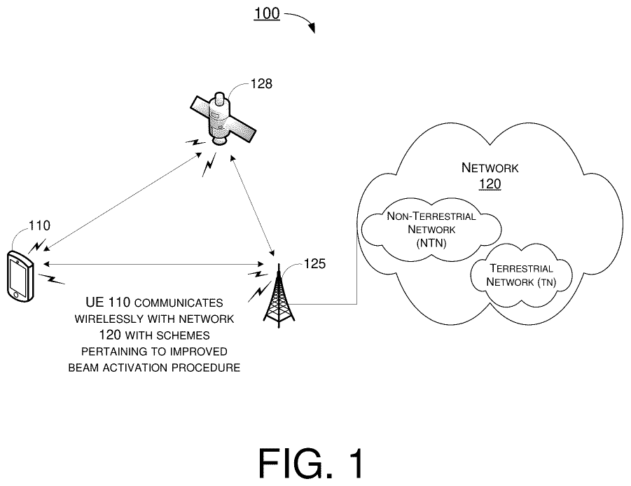

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved beam activation procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to an implementation in accordance with the present disclosure, an apparatus (e.g., the UE 110) may receive a reporting configuration from a network (e.g., the network 120). The reporting configuration may indicate at least one reference signal (RS) resource for the measurement. Then, the apparatus may transmit a measurement report to the network according to the reporting configuration. The measurement report may indicate that at least one RS resource has been synchronized by the apparatus. In addition, the apparatus may receive an activation command from the network. The activation command may indicate (or activate) a target transmission configuration indicator (TCI) state (or indicate (or activate) a target beam) which is not in an active TCI state list. Then, the apparatus may determine whether the RS resource associated with the target TCI state has been reported as synchronized. The apparatus shall be able to receive PDCCH or PDSCH with the target TCI state from the network after an acknowledgement from the apparatus for the activation command is received by the network in an event that the RS resource associated with the target TCI state has been reported as synchronized in the measurement report. If only one target TCI state is activated via the activation command, then UE shall receive PDSCH or PDCCH with the target TCI state. If more than one target TCI states are activated via the activation command, an additional NW signaling (i.e., DCI) indicates the target TCI state with which the UE shall receive PDCCH or PDSC. The target TCI state may be associated with a cell or a network node which is the same as or different from the original serving cell or the original serving network node in the network. That is, the apparatus may receive PDCCH or PDSCH with the target TCI state from a cell (or network node) which is the same as or different from the serving cell (or serving network node) in the network.

According to an implementation in accordance with the present disclosure, the acknowledgement from the apparatus may be received by the network at a timing which is after a delay (e.g., a certain delay) after the apparatus transmits the acknowledgement.

According to some implementations of in accordance with the present disclosure, the target TCI state may be known. The target TCI state is known in an event the following conditions are met. The conditions may comprise that the activation command is received within 1280 milliseconds (ms) upon the last transmission of the RS resource for beam reporting or measurement. The conditions may also comprise that the apparatus has sent at least one layer 1-reference signal received power (L1-RSRP) report for the target TCI state before the activation command. The conditions may further comprise that the target TCI state remains detectable during the TCI state activation period. The conditions may further comprise that the SSB associated with the target TCI state remain detectable during the TCI state activation period (e.g., signal to noise ratio (SNR) ≥−3 dB).

According to an implementation in accordance with the present disclosure, the measurement report may comprise at least one of a period channel state information (CSI) report, a semi-persistent CSI report, an aperiodic CSI report, and an event-driven CSI report.

According to an implementation in accordance with the present disclosure, in the measurement report, a one-bit indicator may indicate whether the RS resource is synchronized by the apparatus.

According to an implementation in accordance with the present disclosure, all the RS resources in the measurement report may be determined as synchronized in an event that a higher layer parameter is configured in the reporting configuration. For example, the higher layer parameter may be configured by a radio resource control (RRC) configuration.

According to an implementation in accordance with the present disclosure, the RS resource meeting a condition of an event to trigger the measurement report may be determined as synchronized.

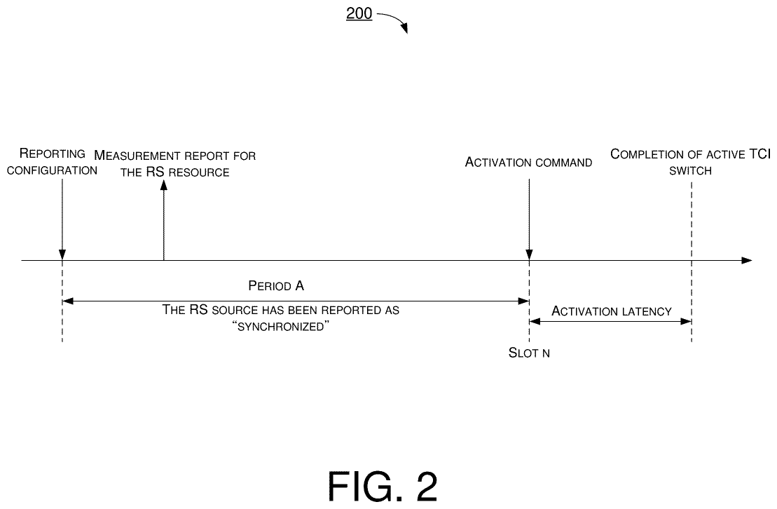

According to an implementation in accordance with the present disclosure, the apparatus may transmit the measurement report to the network in a duration (e.g., period A shown in FIG. 2) from a last transmission of the RS resource to a reception of the activation command.

According to an implementation in accordance with the present disclosure, the activation command may be carried in a medium access control (MAC) control element (MAC CE). That is, the network may transmit the activation command through the MAC CE.

Under a first proposed scheme in accordance with the present disclosure, the measurement report may comprise an L1-RSRP measurement report.

Specifically, in the first proposed scheme, the apparatus may receive a MAC-CE activation command from the network in the slot n. The MAC-CE activation command may indicate the target TCI state (known TCI state) which is not in the active TCI state list. The apparatus may receive PDCCH or PDSCH with the target TCI state at the first slot which is after slot n+(T_{HARQ}+3Nₛₗₒₜ^{subframe,μ}) in an event that the RS resource used for the L1-RSRP measurement reporting for the target TCI state has been reported as “synchronized” in the latest L1-RSRP measurement report during the period (e.g., period A shown in FIG. 2) of the apparatus transmitting the L1-RSRP measurement report to the network. T_{HARQ} is a timing (e.g., T_{HARQ}) of transmitting an acknowledgement for the activation command (or a timing between the DL data transmission and acknowledgement). 3Nₛₗₒₜ^{subframe,μ} may be related to the numerology parameter slot configuration. For example, 3Nₛₗₒₜ^{subframe,μ} may be a certain delay in term of symbol slot determined according to the numerology parameter configuration. 3Nₛₗₒₜ^{subframe,μ} may comprise the network node processing time for UE acknowledgement. That is, if an RS resource is reported as “synchronized” in the latest L1-RSRP measurement report, the apparatus may not need to receive the SSB associated with the target TCI state after receiving the MAC-CE activation command from the network (i.e., T_{d}=T_{HARQ}+3Nₛₗₒₜ^{subframe,μ}, TOₖ=0). Therefore, the activation latency (i.e., T_{d}) can be reduced.

According to an implementation in accordance with the present disclosure, in the first proposed scheme, the L1-RSRP measurement report may comprise at least one of a periodic CSI report, a semi-persistent CSI report, an aperiodic CSI report, and an event-driven CSI report.

According to an implementation in accordance with the present disclosure, in the first proposed scheme, a one-bit indicator may be used to indicate the RS resource which has been synchronized by the apparatus in the L1-RSRP measurement report.

According to an implementation in accordance with the present disclosure, in the first proposed scheme, all the RS resources in the L1-RSRP measurement report may be determined as synchronized in an event that a higher layer parameter is configured in the reporting configuration for the L1-RSRP measurement report.

According to an implementation in accordance with the present disclosure, in the first proposed scheme, an RS resource meeting a condition of an event to trigger (or drive) the L1-RSRP measurement report may be determined as synchronized. That is, the L1-RSRP measurement report may be an event-triggered (or event-driven) CSI report.

According to an implementation in accordance with the present disclosure, in the first proposed scheme, the period (e.g., period A shown in FIG. 2) of the apparatus transmitting the L1-RSRP measurement report to the network may comprise (or be defined as) a duration from a last transmission of the RS resource used for the L1-RSRP measurement report for the target TCI state to a reception of the MAC-CE activation command in the slot n.

Under a second proposed scheme in accordance with the present disclosure, the apparatus (e.g., UE) may determine whether an RS resource in the target TCI state or a quasi-co-location (QCL) RS resource in the target TCI state (i.e., the RS resource associated with the target TCI state may comprise a QCL source RS of the target TCI state, or comprise an RS that is quasi co-located with a QCL resource of the target TCI state) has been reported as synchronized.

Specifically, in the second proposed scheme, the apparatus may receive a MAC-CE activation command from the network in the slot n. The MAC-CE activation command may indicate the target TCI state (known TCI state) which is not in the active TCI state list. The apparatus may receive PDCCH or PDSCH with the target TCI state at the first slot which is after slot n+(T_{HARQ}+3Nₛₗₒₜ^{subframe,μ}) in an event that the RS resource in the target TCI state or the QCL RS resource in the target TCI state has been reported as “synchronized” by the apparatus during the period (e.g., period A shown in FIG. 2) of the apparatus transmitting the measurement report to the network. T_{HARQ} is a timing (e.g., T_{HARQ}) of transmitting an acknowledgement for the activation command (or a timing between the DL data transmission and acknowledgement). 3Nₛₗₒₜ^{subframe,μ} may be related to the numerology parameter configuration. That is, if an RS resource is reported as “synchronized” by the apparatus, the apparatus may not need to receive the SSB associated with the target TCI state after receiving the MAC-CE activation command from the network (i.e., T_{d}=T_{HARQ}+3Nₛₗₒₜ^{subframe,μ}, TOₖ=0). Therefore, the activation latency (i.e., T_{d}) can be reduced.

According to an implementation in accordance with the present disclosure, in the second proposed scheme, the measurement report may comprise at least one of a periodic CSI report, a semi-persistent CSI report, an aperiodic CSI report, and an event-driven CSI report.

According to an implementation in accordance with the present disclosure, in the second proposed scheme, a one-bit indicator may be used to indicate the RS resource which has been synchronized by the apparatus in the measurement report.

According to an implementation in accordance with the present disclosure, in the second proposed scheme, all the RS resources in the measurement report may be determined as synchronized in an event that a higher layer parameter is configured in the reporting configuration for the measurement report.

According to an implementation in accordance with the present disclosure, in the second proposed scheme, an RS resource meeting a condition of an event to trigger (or drive) the measurement report may be determined as synchronized. That is, the measurement report may be an event-triggered (or event-driven) CSI report.

According to an implementation in accordance with the present disclosure, in the second proposed scheme, the period (e.g., period A shown in FIG. 2) of the apparatus transmitting the measurement report to the network may comprise (or be defined as) a duration from a last transmission of the RS resource in the target TCI state or the QCL RS resource in the target TCI state to a reception of the MAC-CE activation command in the slot n.

FIG. 2 illustrates an example scenario 200 of a beam activation procedure in which various solutions and schemes in accordance with the present disclosure may be implemented. Scenario 200 involves a UE and a wireless communication network (e.g., an LTE network, a 5G/NR network, an IoT network or a 6G network) which may comprise a plurality of network nodes (or cells). Referring to FIG. 2, a UE may receive a reporting configuration from a wireless communication network. Then, the UE may transmit a measurement report to the wireless communication network during a period A according to the reporting configuration. The measurement report may indicate that at least one RS resource has been synchronized by the UE. In addition, the UE may receive an activation command from the wireless communication network at slot n. The activation command may indicate (or activate) a target transmission configuration indicator (TCI) state which is not in an active TCI state list (or indicate (or activate) a target beam). Then, the UE may determine whether the target TCI state is associated with the at least one RS resource which has been reported as synchronized. The UE may receive PDCCH or PDSCH with the target TCI state from the wireless communication network (i.e., the TCI switch (or beam switch) is completed) without receiving an SSB associated with the target TCI state from the wireless communication network in an event that the RS resource associated with the target TCI state has been reported as synchronized. Referring to FIG. 2, the activation latency Ta may only comprise T_{HABQ}+3Nₛₗₒₜ^{subframe,μ} Therefore, the activation latency can be reduced.

In some implementations, the activation latency Ta for the beam/TCI state indicated in the activation command may be defined as follow. If the beam/TCI state is known, then

$${T}_{d} = {T}_{H A R Q} + 3 {N}_{slot}^{subframe , μ} + {TO}_{k} * \frac{{T}_{first - SSB} + {T}_{S S B - p r o c}}{NR slot length} .$$

T_{HARQ} is the timing between DL data transmission and acknowledgement. TOₖ=0 if the beam/TCI state is in the active TCI state list for PDSCH, TOₖ=1 otherwise. In one example, TOₖ=0 if the beam/TCI state is in the active TCI state list for PDSCH or if the RS source used for the L1-RSRP measurement reporting for the target TCI state has been reported as “synchronized” in the latest L1-RSRP report during Period A, TOₖ=1 otherwise. In one example, TOₖ=0 if the beam/TCI state is in the active TCI state list for PDSCH or if the RS source in the target TCI state or QCLed to the target TCI state has been reported as “synchronized” by the UE during Period A, TOₖ=1 otherwise. T_{frist-SSB} is time to first SSB transmission after the activation command is decoded by the UE. The SSB shall be the QCL-TypeA or QCL-TypeC to target TCI state. T_{SSB-proc}=2 ms.

### Illustrative Implementations

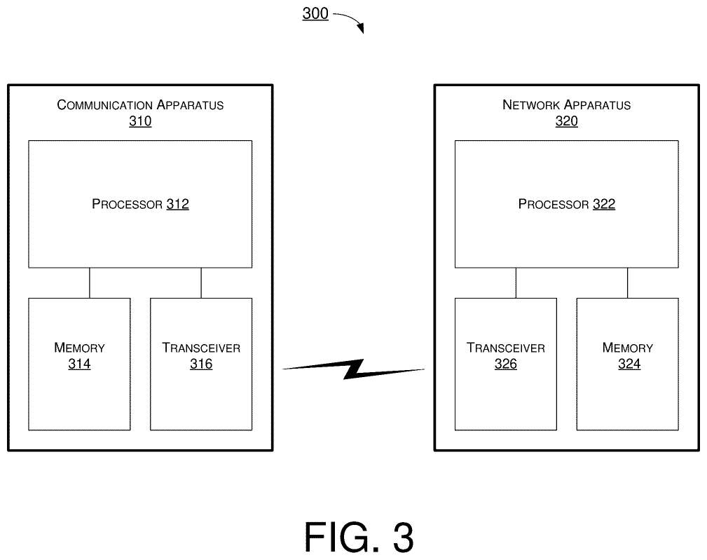

FIG. 3 illustrates an example communication system 300 having at least an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to beam activation procedure, including the various schemes described above with respect to various proposed designs, concepts, schemes and methods described above and with respect to user equipment and network apparatus in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 310 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed schemes of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a satellite, a BS, a small cell, a router or a gateway of an IoT network. For instance, network apparatus 320 may be implemented in a satellite or an eNB/gNB/TRP in a 4G/5G/B5G/6G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks, including enhanced beam activation procedure, in a device (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of UEs and/or wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 310 and network apparatus 320 may be a communication entity capable of communicating with each other using various proposed schemes in accordance with the present disclosure. For illustrative purposes and without limitation, descriptions of capabilities of communication apparatus 310, as a UE, and network apparatus 320, as a network node (e.g., TRP), are provided below with process 400 and process 500.

### Illustrative Processes

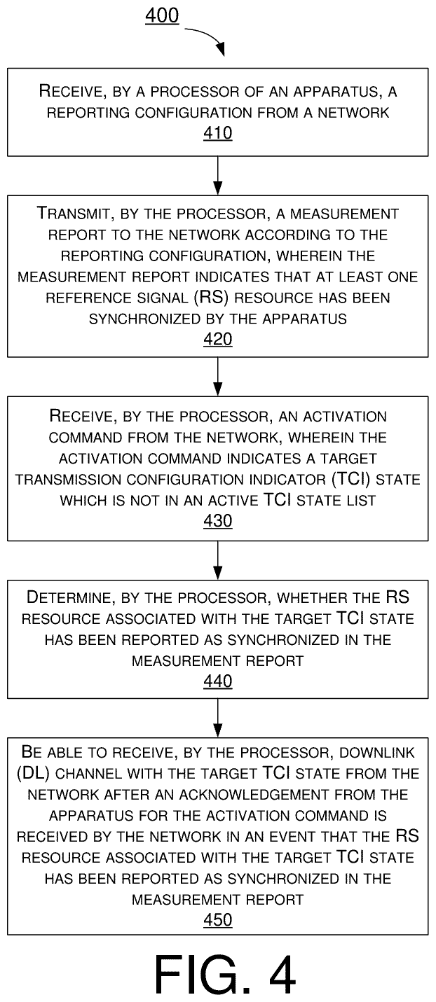

FIG. 4 illustrates an example process 400 in accordance with an implementation of the present disclosure. Process 400 may be an example implementation of above scenarios/schemes, whether partially or completely, with respect to beam activation procedure with the present disclosure. Process 400 may represent an aspect of implementation of features of communication apparatus 310. Process 400 may include one or more operations, actions, or functions as illustrated by one or more of blocks 410, 420, 430, 440 and 450. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310. Solely for illustrative purposes and without limitation, process 400 is described below in the context of communication apparatus 310. Process 400 may begin at block 410.

At block 410, process 400 may involve processor 312 of communication apparatus 310 receiving, via transceiver 316, a reporting configuration from a network. Process 400 may proceed from block 410 to block 420.

At block 420, process 400 may involve processor 312 transmitting, via transceiver 316, a measurement report to the network according to the reporting configuration, wherein the measurement report may indicate that at least one RS resource has been synchronized by the apparatus. Process 400 may proceed from block 420 to block 430.

At block 430, process 400 may involve processor 312 receiving, via transceiver 316, an activation command from the network, wherein the activation command indicates a target TCI state which is not in an active TCI state list. Process 400 may proceed from block 430 to block 440.

At block 440, process 400 may involve processor 312 determining whether the RS resource associated with the target TCI state has been reported as synchronized in the measurement report. Process 400 may proceed from block 440 to block 450.

At block 450, process 400 may involve processor 312 being able to receive, via transceiver 316, DL channel with the target TCI state from the network after an acknowledgement from the communication apparatus 310 for the activation command is received by the network in an event that the RS resource associated with the target TCI state has been reported as synchronized in the measurement report.

In some implementations, the acknowledgement may be received by the network at a timing which is after a delay after the communication apparatus 310 transmits the acknowledgement.

In some implementations, the measurement report may comprise an L1-RSRP measurement report.

In some implementations, the measurement report may comprise at least one of a periodic CSI report, a semi-persistent CSI report, an aperiodic CSI report, and an event-driven CSI report.

In some implementations, the RS resource associated with the target TCI state may comprise a QCL source RS of the target TCI state or an RS that is quasi-co-located with a QCL source RS of the target TCI state.

In some implementations, in the measurement report, a one-bit indicator may indicate the RS resource is synchronized by the apparatus.

In some implementations, all the RS resources in the measurement report may be determined as synchronized in an event that a higher layer parameter is configured in the reporting configuration.

In some implementations, the RS resource meeting a condition of an event to trigger the measurement report may be determined as synchronized.

In some implementations, the measurement report is transmitted in a duration from a last transmission of the RS resource to a reception of the activation command.

In some implementations, the activation command may be carried in an MAC CE.

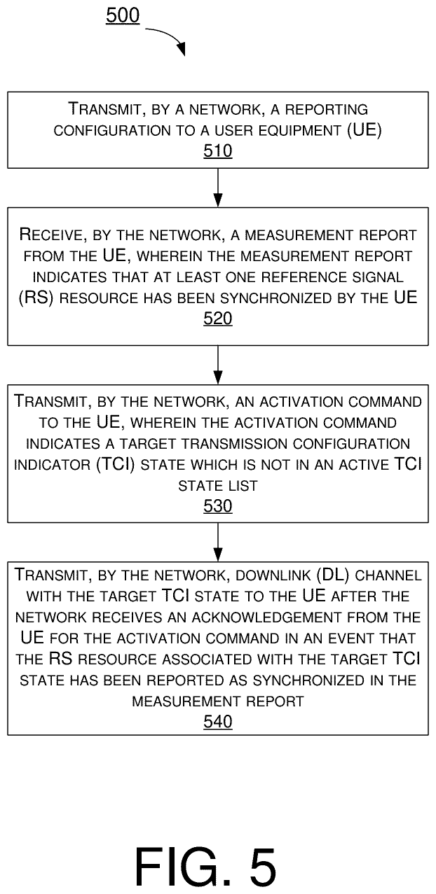

FIG. 5 illustrates an example process 500 in accordance with another implementation of the present disclosure. Process 500 may be an example implementation of above scenarios/schemes, whether partially or completely, with respect to beam activation procedure with the present disclosure. Process 500 may represent an aspect of implementation of features of network apparatus 320. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320. Solely for illustrative purposes and without limitation, process 500 is described below in the context of network apparatus 320. Process 500 may begin at block 510.

At block 510, process 500 may involve processor 322 of network apparatus 320 transmitting, via transceiver 326, a reporting configuration to a UE. Process 500 may proceed from block 510 to block 520.

At block 520, process 500 may involve processor 322 receiving, via transceiver 326, a measurement report from the UE, wherein the measurement report indicates that at least one RS resource has been synchronized by the UE. Process 500 may proceed from block 520 to block 530.

At block 530, process 500 may involve processor 322 of network apparatus 320 transmitting, via transceiver 326, an activation command to the UE, wherein the activation command indicates a TCI state which is not in an active TCI state list. Process 500 may proceed from block 530 to block 540.

At block 540, process 500 may involve processor 322 of network apparatus 320 transmitting, via transceiver 326, DL channel with the target TCI state to the UE after the network apparatus 320 receives an acknowledgement from the UE for the activation command in an event that the RS resource associated with the target TCI state has been reported as synchronized.

In some implementations, the acknowledgement may be received by the network at a timing which is after a delay after the acknowledgement is transmitted by the UE.

In some implementations, the measurement report may comprise an L1-RSRP measurement report.

In some implementations, the measurement report may comprise at least one of a periodic CSI report, a semi-persistent CSI report, an aperiodic CSI report, and an event-driven CSI report.

In some implementations, the RS resource associated with the target TCI state may comprise a QCL source RS of the target TCI state or an RS that is quasi-co-located with a QCL source RS of the target TCI state.

In some implementations, in the measurement report, a one-bit indicator may indicate whether the RS resource is synchronized by the UE.

In some implementations, process 500 may involve processor 322 configuring a higher layer parameter to indicate that all the RS resources in the measurement report are determined as synchronized.

In some implementations, the RS resource meeting a condition of an event to trigger the measurement report may be determined as synchronized.

In some implementations, the measurement report is received in a duration from a last reception of the RS resource to a transmission of the activation command.

In some implementations, the activation command may be carried in an MAC CE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a reporting configuration from a network;
transmitting, by the processor, a measurement report to the network according to the reporting configuration, wherein the measurement report indicates that at least one reference signal (RS) resource has been synchronized by the apparatus;
receiving, by the processor, an activation command from the network, wherein the activation command indicates a target transmission configuration indicator (TCI) state which is not in an active TCI state list;
determining, by the processor, whether the RS resource associated with the target TCI state has been reported as synchronized in the measurement report; and
being able to receive, by the processor, downlink (DL) channel with the target TCI state from the network after an acknowledgement from the apparatus for the activation command is received by the network in an event that the RS resource associated with the target TCI state has been reported as synchronized in the measurement report.

2. The method of claim 1, wherein the acknowledgement is received by the network at a timing which is after a delay after the apparatus transmits the acknowledgement.

3. The method of claim 1, wherein the measurement report comprises a layer 1-reference signal received power (L1-RSRP) measurement report.

4. The method of claim 1, wherein the measurement report comprises at least one of a periodic channel state information (CSI) report, a semi-persistent CSI report, an aperiodic CSI report, and an event-driven CSI report.

5. The method of claim 1, wherein the RS resource associated with the target TCI state comprises a quasi-co-location (QCL) source RS of the target TCI state or an RS that is quasi-co-located with a QCL source RS of the target TCI state.

6. The method of claim 1, wherein in the measurement report, a one-bit indicator indicates whether the RS resource reported in the measurement report is synchronized by the apparatus.

7. The method of claim 1, wherein all the RS resources in the measurement report are determined as synchronized in an event that a higher layer parameter is configured in the reporting configuration.

8. The method of claim 1, wherein the RS resource meeting a condition of an event to trigger the measurement report is determined as synchronized.

9. The method of claim 1, wherein the measurement report is transmitted in a duration from a last transmission of the RS resource to a reception of the activation command.

10. The method of claim 1, wherein the activation command is carried in a medium access control (MAC) control element (MAC CE).

11. A method, comprising:
transmitting, by a network, a reporting configuration to a user equipment (UE);
receiving, by the network, a measurement report from the UE, wherein the measurement report indicates that at least one reference signal (RS) resource has been synchronized by the UE;
transmitting, by the network, an activation command to the UE, wherein the activation command indicates a target transmission configuration indicator (TCI) state which is not in an active TCI state list; and
transmitting, by the network, downlink (DL) channel with the target TCI state to the UE after the network node receives an acknowledgement from the UE for the activation command in an event that the RS resource associated with the target TCI state has been reported as synchronized in the measurement report.

12. The method of claim 11, wherein the acknowledgement is received by the network at a timing which is after a delay after the acknowledgement is transmitted by the UE.

13. The method of claim 11, wherein the measurement report comprises a layer 1-reference signal received power (L1-RSRP) measurement report.

14. The method of claim 11, wherein the measurement report comprises at least one of a periodic channel state information (CSI) report, a semi-persistent CSI report, an aperiodic CSI report, and an event-driven CSI report.

15. The method of claim 11, wherein the RS resource associated with the target TCI state comprises a quasi-co-location (QCL) source RS of the target TCI state or an RS that is quasi-co-located with a QCL source RS of the target TCI state.

16. The method of claim 11, wherein in the measurement report, a one-bit indicator indicates whether the RS resource reported in the measurement report is synchronized by the UE.

17. The method of claim 11, further comprising:
configuring, by the network, a higher layer parameter to indicate that all the RS resources in the measurement report are determined as synchronized.

18. The method of claim 11, wherein the RS resource meeting a condition of an event to trigger the measurement report is determined as synchronized.

19. The method of claim 11, wherein the measurement report is received in a duration from a last reception of the RS resource to a transmission of the activation command.

20. The method of claim 11, wherein the activation command is carried in a medium access control (MAC) control element (MAC CE).
